(19) United States
(12) Patent Application Publication
(10) Pub. No.: US 2017/0173613 A1
(43) Pub. Date: Jun. 22, 2017

(54) BODY-WORN/CARRIED PUMP STATION

(71) Applicant: Hove A/S, Glostrup (DK)

(72) Inventors: Thomas Hove, Gentofte (DK); William Lisby, Svendborg (DK); Ivan Madsen, Odense Sv (DK); Thomas Cramer, Rødovre (DK)

(73) Assignee: Hove A/S, Glostrup (DK)

(21) Appl. No.: 15/124,081

(22) PCT Filed: Mar. 6, 2015
(86) PCT No.: PCT/DK2015/050048

§ 371 Date: Sep. 7, 2016

(30) Foreign Application Priority Data
Mar. 7, 2014 (DK) PA 2014 70114
Apr. 3, 2014 (DK) PA 2014 70169

(51) Int. Cl. B05B 9/08; F16L 37/38; F16L 37/26; A45F 3/02

(52) U.S. Cl. CPC B05B 9/08; A45F 3/02; F16L 37/38; F16L 37/26; A45F 2003/166

(57) ABSTRACT

The invention regards in a first aspect a body-worn/carried pump station comprising a housing having at least one compartment, in said housing having at least a pump, a motor and an internal power supply, where said motor is powered by said internal power supply, and a container comprising material to be pumped, wherein said pump has means for connecting said container, at least one hose connected to said pump in one end and connected to a dispensing means in the other end for dispensing material pumped from the container, control means for start/stop and/or for controlling and/or setting up said pump station, and a display, wherein at least said control means or said display is located remotely from said pump station. The invention regards in second aspect a container connector assembly, comprising: a first connector comprising a first inlet and first outlet, a second connector comprising a second inlet a second outlet, a first mounting means on said first connector for connecting said first connector to a container comprising a container opening, a second mounting means on said first connector for connecting said first connector to second connector, a third mounting means on said second connector for receiving said first connector, a fourth mounting means on said second connector for connecting said second connector to a device comprising a device opening, a valve inside said first connector and/or inside said second connector to be opened and closed, wherein said second and/or third mounting means is configured for connecting said first connector to said second connector by a translational movement of said connector(s), and wherein said translational movement is substantially perpendicular to an axis formed along said first outlet and second inlet when the connectors are connected.

### FIELD OF INVENTION

The invention relates in a first aspect to a body-worn/carried pump station. Specifically, the invention relates to a body-worn/carried pump station for dispensing pumpable material, such as oil, grease, sealants and other liquids, in order, for example to lubricate various machine parts or seal windows at construction sites. In a second aspect, the invention relates to an assembly for connecting a container to a device, in particular a container connector assembly for a device such as a pump, in particular the pump in the pump station described by the first aspect.

### BACKGROUND OF THE INVENTION

When dispensing liquids at locations, which are difficult to access or to subjects scattered on a large area, it is necessary to carry a dispensing tool/pump and liquids around. Several risks are related to carrying a dispensing tool/pump and liquids around. First of all, it may be heavy and cause damage to the body if the person is not strong enough. Secondly, it may not be easy to move around with the dispensing tool/pump and liquids, for example if climbing ladders or moving in confined spaces.

One solution to dispensing liquids at locations which are difficult to access or to subjects scattered on a large area, is to carry a pump and a container to a subject, place the pump, open the pump case, and attach the pump to a container comprising the pumpable material. In order to move on to the next location, it is required to detach the container from the pump in order to reduce weight and size so that it is possible to go to the next location. From here, the procedure is repeated. Since the pump is heavy and unhandy, it is not possible to carry the pump case and at the same time work with both hands.

Currently, there exist no body worn/carried dispensing tool/pump, in particular for large industrial facilities, where the machine parts are more than meters apart, for example at separate ends of the facility, or even high above ground level.

As a consequence, dispensing a liquid using the described solution for dispensing liquids at locations which are difficult to access or to subjects scattered on a large area is not only a physically demanding job, but also a health risking job.

When dispensing pumpable material from a container, the pump needs to be connected to the container with the pumpable material.

A typical connection is for example a soap dispenser as for example for dispensing soap to people washing hands. The soap dispenser typically consists of a container and a pump which is screwed onto the container. In small scale pumps like soap dispensers, screwing either the pump or the container may be relatively easy because both the pump and the container may be light weight.

However, there may be large scale pumps, or at least pumps larger than soap dispensers, which may not always be easy to handle, in particular the pump and the container may be difficult to screw on to each other. In some cases, the pump may be relatively heavy and/or in some cases, the container may be relatively heavy, whereby the connection handling is difficult.

In solutions, where screwing is involved, there may be solutions where a valve is opened before the container is completely connected to the pump. In such cases, the pumpable material may be dripping or even flow out of the container and in some cases imply a potential risk for damaging the pump or other system parts. In particular, there are solutions, where the container may be attached to the pump upside down, and in such cases, the pumpable material may definitely flow out of the container and directly down to the pump with high risk for damaging the pump.

What is missing is a container connector assembly that may allow for a user-friendly mounting, i.e. fast and easy, and also allows for a mounting, such that a valve is opened after the container is connected to the pump.

### SUMMARY OF THE INVENTION

Considering the need as above described, it is a first object of the present invention to provide a body worn/carried pump station suitable for dispensing a liquid on site, no matter where.

Body worn/carried devices are specifically made for carrying on the body, and need to be light-weight and comfortable. Furthermore, body worn/carried devices needs to be easy to handle.

The object can be achieved by means of providing a body-worn/carried pump station comprising a housing having at least one compartment, in said housing having at least a pump, a motor and an internal power supply, where said motor is powered by said internal power supply, and a container comprising material to be pumped, wherein said pump has means for connecting said container, at least one hose connected to said pump in one end and connected to a dispensing means in the other end for dispensing material pumped from the container, control means for start/stop and/or for controlling and/or setting up said pump station, and a display, wherein at least said control means or said display is located remotely from said pump station.

Thus, it is possible to carry or wear the body-worn/carried pump into confined spaces. It may also be possible to carry or wear the body-worn/carried pump in large areas.

In the given areas or spaces, it is the first objective to dispense material, comprising the step of providing a body-worn/carried pump station and dispensing material.

In order to solve the above described problems and address the above described need, the present disclosure relates in a second aspect to a container connector assembly that is fast and easy to connect to a device such as pump.

Accordingly, the present disclosure provides a container connector assembly, comprising: a first connector comprising a first inlet and first outlet, a second connector comprising a second inlet a second outlet, a first mounting means on said first connector for connecting said first connector to a container comprising a container opening, a second mounting means on said first connector for connecting said first connector to second connector, a third mounting means on said second connector for receiving said first connector, a fourth mounting means on said second connector for connecting said second connector to a device comprising a device opening, a valve inside said first connector and/or inside said second connector to be opened and closed, wherein said second and/or third mounting means is configured for connecting said first connector to said second connector by a translational movement of said connector(s), and wherein said translational movement is substantially perpendicular to an axis formed along said first outlet and second inlet when the connectors are connected.

The translational movement is as described, preferably substantially perpendicular to an axis formed along said first outlet and second inlet when the connectors are connected. However, there may be configurations, wherein the translational movement is different from an axis parallel to the axis formed along said first outlet and second inlet when the connectors are connected.

One purpose of having the translational movement configured as described may be that this allows for an easy connection of a container and a device, in particular a pump, where for example, there is a housing for the pump. In this case, the translational movement may be substantially perpendicular to the axis formed along the major axis of the housing of pump.

In a preferred embodiment of the present disclosure, the valve is in the first connector since the first connector is connected to the container.

In another embodiment of the present disclosure, the container connector assembly further comprising locking means on said connector, preferably on the second connector. One advantage of the locking means is that the locking means locks the container after the container is connected to the device. Furthermore, an advantage of the locking means is that the locking means may open the valve such that the valve opens after the container is connected to the device, thereby preventing dripping or flow of pumpable material from the container.

In yet another embodiment of the present disclosure, the particular device is a pump, and accordingly, the present disclosure provides a pump system, comprising: a pump comprising a pump opening, a container comprising a container opening, a first connector comprising a first inlet and first outlet, a second connector comprising a second inlet a second outlet, a first mounting means on said first connector for connecting said first connector to said container, a second mounting means on said first connector for connecting said first connector to second connector, a third mounting means on said second connector for receiving said first connector, a fourth mounting means on said second connector for connecting said second connector to said pump, a valve inside said first connector or inside said second connector to be opened and closed, wherein said second and/or third mounting means is configured for connecting said first connector to said second connector by a translational movement of said connector(s), wherein said translational movement is substantially perpendicular to an axis formed along said first outlet and second inlet when the connectors are connected, and having one or more features as described in the following details.

### DESCRIPTION OF THE DRAWINGS

The invention will in the following be described in greater detail with reference to the accompanying drawings:

FIG. 1 a perspective view of one embodiment of a body-worn/carried pump station.

FIG. 2 a perspective view of one embodiment of a body-worn/carried pump station.

FIG. 3 a perspective view of one embodiment of a body-worn/carried pump station.

FIG. 4 a perspective view of one embodiment of the control means.

FIG. 5 a photograph of one embodiment of a container.

FIG. 6 Perspective view of one embodiment of a container connector assembly according the present disclosure.

FIG. 7 Perspective view of one embodiment of a container connector assembly according the present disclosure.

### DETAILED DESCRIPTION OF THE INVENTION

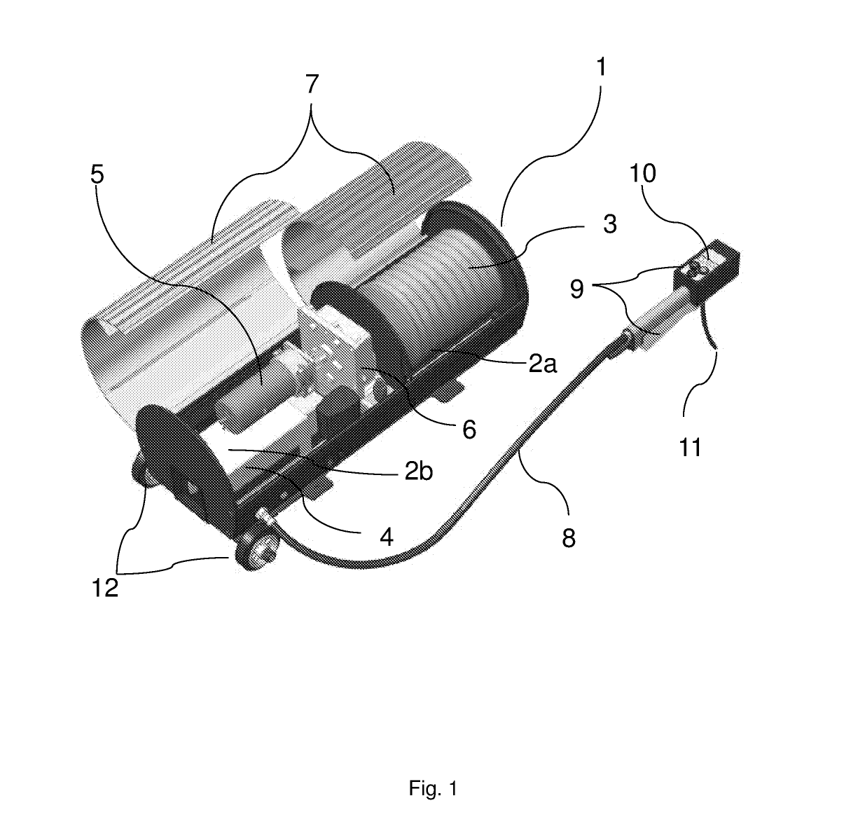

FIG. 1 shows a perspective view of one embodiment of a body-worn/carried pump station. The housing 1 comprises two compartments, a first compartment 2a and a second compartment 2b. The first compartment 2a has a container 3. The second compartment has a battery 4, a motor 5 and a pump 6. The two compartments are each equipped with a door 7. The body-worn/carried pump station further has a hose 8, connected to the control means 9, with an integrated display 10, and dispensing means 11. The housing of the body-worn/carried pump is provided with wheels 12.

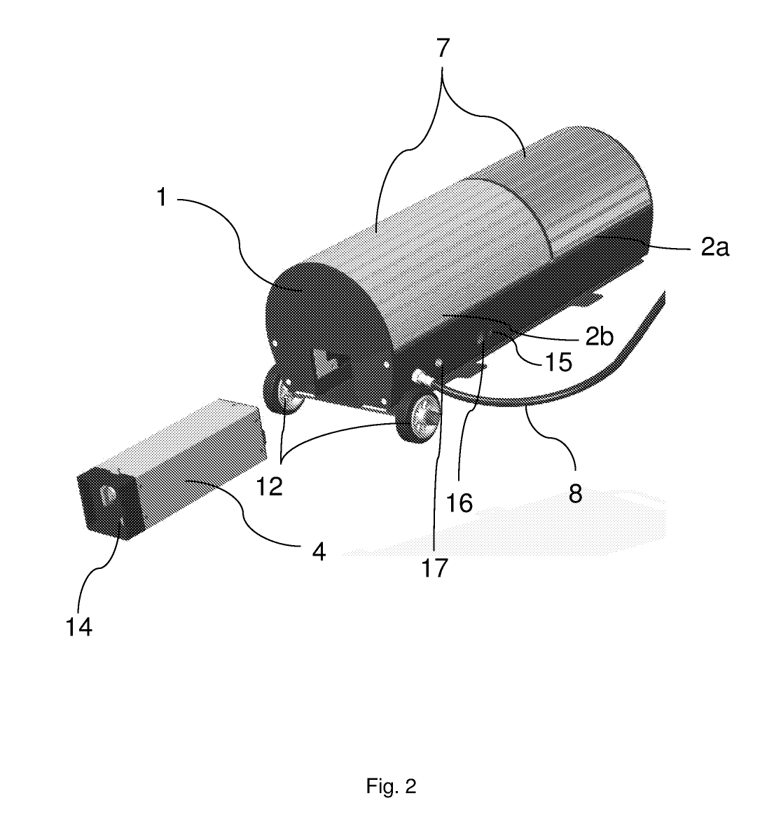

FIG. 2 shows a perspective view of one embodiment of a body-worn/carried pump station. The two compartments have closed doors 7. The battery is shown as detached from the second compartment 2b. In the end of the battery is a plugin for charging 14. The external power supply plugin 15 is on the side of the housing next to the on/off switch 16. The adaptor for wired communication 17 is next to the plugin of the hose 8.

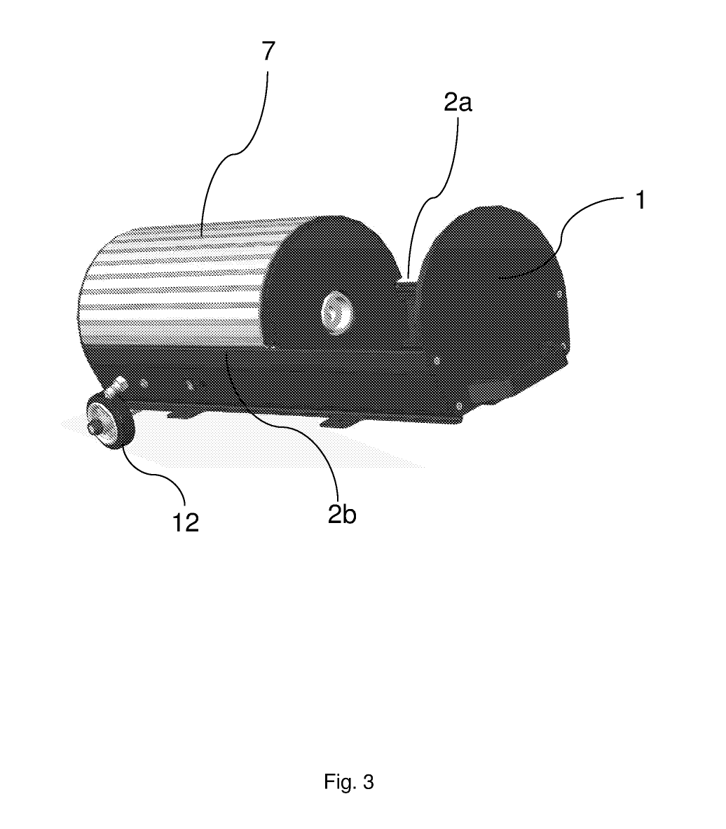

FIG. 3 shows a perspective view of one embodiment of a body-worn/carried pump station. The first compartment 2a does not have a door, whereas the second compartment 2b has a closed door. A container is detached from the first compartment 2a.

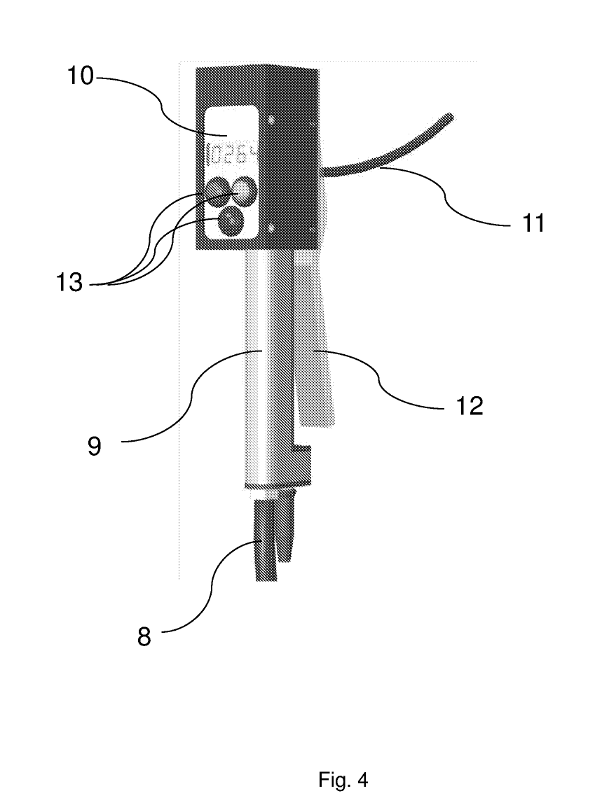

FIG. 4 shows a perspective view of one embodiment of the control means 9. The control means has an integrated display 10 and dispensing means 11. The control means includes a control of the pump, such as a control of open/close 12, a control of flow 13, and/or a control of pressure 13. The control means is located on the dispensing means 11.

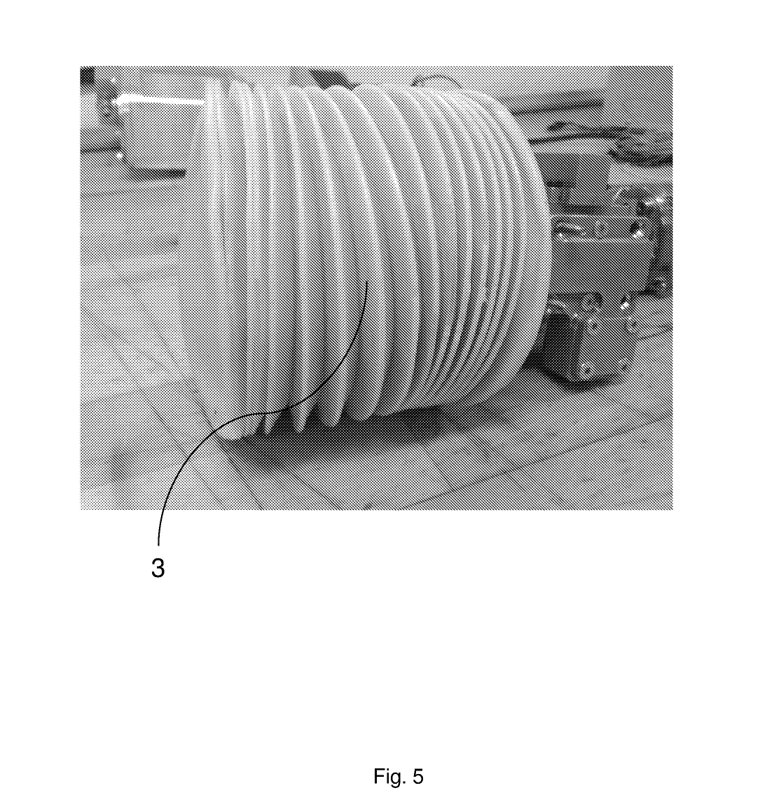

FIG. 5 shows a photograph of one embodiment of a container. The container 3 is partly collapsed.

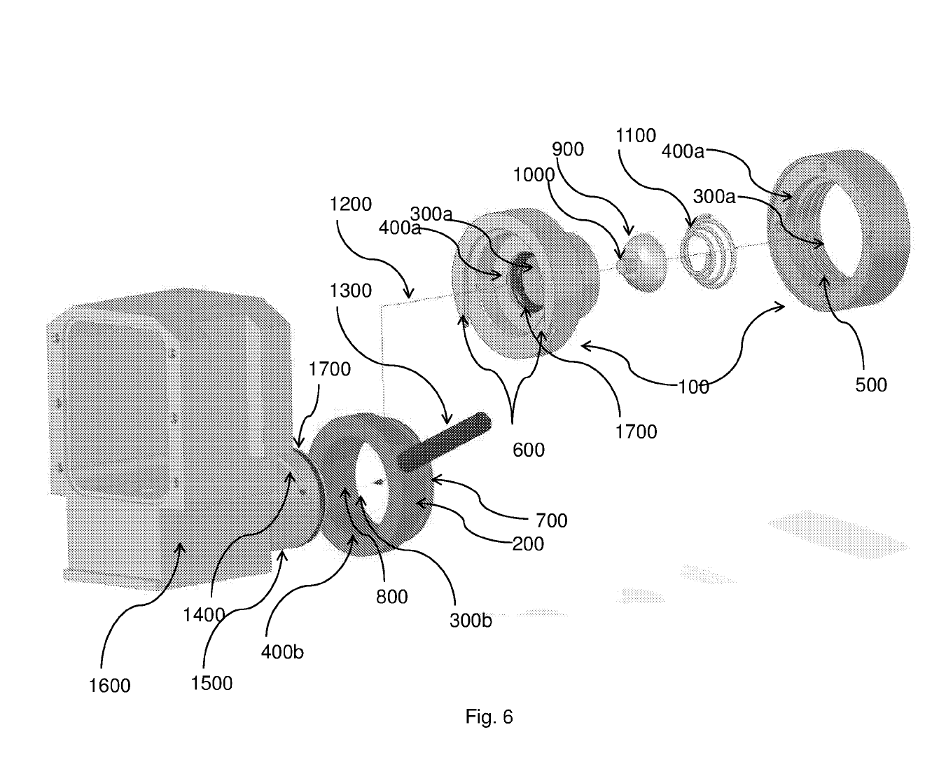

FIG. 6 shows a perspective view of one embodiment of a container connector assembly according to the present disclosure. A first connector 100 and a second connector 200 are shown separated in FIG. 6. In the shown embodiment, the first connector 100 is made up of two connectors, each with a first inlet 300a and a first outlet 400a. The second connector comprises a second inlet 300b and a second outlet 400b. A first mounting means 500 is a threaded mount to be connected to a container. A second mounting means 600 comprises two parallel surfaces which are configured to slide onto a third mounting means 700, which is an annular groove on the second connector 200. A fourth mounting means 800 is an un-threaded mount to be connected to a device. A valve 900 is inside the first connector 100, where it is configured to open and close by applying a force on the valve surface 1000. The valve comprises spring 1100 such that a substantial amount of force is required to open the valve. The third mounting means 700 with the two parallel surfaces are configured such that it is possible to connect the first connector 100 to the second connector 200 by a translational movement of the connector(s), such that the translational movement is substantially perpendicular to an axis 1200 formed along the first outlet 400a and the second inlet 300b when the connectors are connected. The container connector assembly comprises locking means 1300 on the second connector 200, in this case a projection means being a rod, which engages to a groove 1400 on the outer surface 1500 of the device 1600. The first connector 100 and the device 1600 comprise a total of three O-rings 1700; an O-ring 1700 on the device 1600 to seal the device, and two O-rings 1700 on the connector 100; an O-ring 1700 to seal the valve and an O-ring 1700 to seal the container (only visible in FIG. 2).

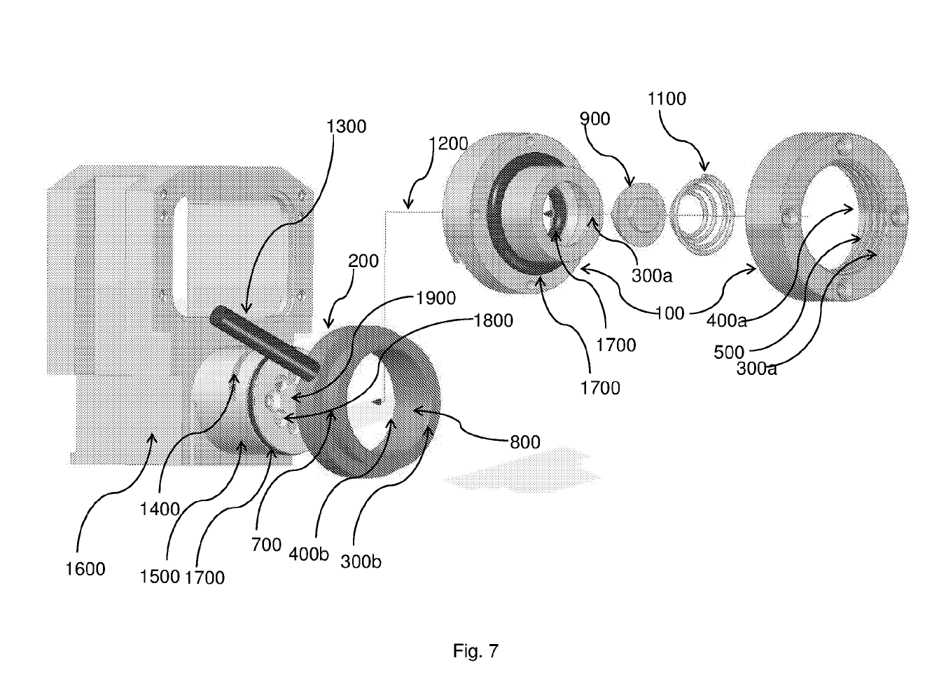

FIG. 7 shows a perspective view of one embodiment of a container connector assembly according to the present disclosure. A first connector 100 and a second connector 200 are shown separated in the figure. In the shown embodiment, the first connector 100 is made up of two connectors, each with a first inlet 300a and a first outlet 400a. The second connector comprises a second inlet 300b and a second outlet 400b. A first mounting means 500 is a threaded mount to be connected to a container. A second mounting means 600 comprises two parallel surfaces (not to be seen from this perspective) which are configured to slide onto a third mounting means 700, which is an annular groove on the second connector 200. A fourth mounting means 800 is an un-threaded mount to be connected to a device. A valve 900 is inside the first connector 100, where it is configured to open and close by applying a force on the valve surface 1000. The valve comprises spring 1100 such that a substantial amount of force is required to open the valve. The third mounting means 700 with the two parallel surfaces are configured such that it is possible to connect the first connector 100 to the second connector 200 by a translational movement of the connector(s), such that the translational movement is substantially perpendicular to an axis 1200 formed along the first outlet 400a and the second inlet 300b when the connectors are connected. The container connector assembly comprises locking means 1300 on the second connector 200, in this case a projection means being a rod, which engages to a groove 1400 on the outer surface 1500 of the device 1600. The first connector 100 and the device 1600 comprise a total of three O-rings 1700; an O-ring 1700 on the device 1600 to seal the device, and two O-rings 1700 on the connector 100; an O-ring 1700 to seal the valve and an O-ring 1700 to seal the container. The device 1600 comprises further an aperture surface 1800, in this case with a solid part in the centre of the opening such that it is possible to apply a pressure on the valve 900, in particular on the valve surface 1000 (seen in FIG. 1). The aperture surface 1800 comprises a plurality of apertures 1900 for allowing pumbable material to enter the device from a container.

### Physical Dimensions of the Body-Worn/Carried Pump Station

In order for the body-worn/carried pump to be as mobile as possible, it is a requirement that the pump station has physical dimensions that are suitable for handling the pump, especially inside confined spaces.

The dimension of the body-worn/carried pump is a trade-off between the necessary amount of liquid to be pumped and thereby carried, and a relevant weight for a body-worn system.

In one embodiment of the present disclosure, the width of the pump station housing is less than 50 cm, more preferably less than 30 cm. Likewise, the total length of the pump station housing is less than 1 meter, more preferably less than 70 cm. Having dimensions like this, allows for the body-worn/carried pump station to carried in limited spaces, for example up narrow stairs.

By the present invention, it has been found that it is possible to reduce the weight of the body-worn/carried pump to 15 kg or less even when including a substantial amount of liquid, which means that it is possible for most people to carry the body-worn station. Hence, in one embodiment of the present disclosure, the total weight of said housing including pump, battery and motor is preferably 15 kg or lower, in particularly if made in metal, whereas if made in plastic the housing may be lower than 13 kg. Preferably the body-worn/carried pump weighs 10 kg or less.

However, for maintenance, it is essential that there is enough material to be dispensed, and thus in one embodiment of the present disclosure, the container may comprise at least 1 liter of material, such as at least 2 l of material, such as at least 3 l of material. In particularly, the container may contain 1.5, 3.0 or 5.0 liters of material.

In one embodiment, the total length of the compartment is adjustable. In this manner, the physical dimensions can be adjusted to the space wherein the body-worn/carried pump is to be used.

In another embodiment of the present disclosure, the length of the container is configured to the length of the compartment. This means, that if a user for example only needs to dispense 1 liter of material, the user may use a relatively small container and adjust the length of the compartment to the length of the container. Alternatively, if the user decides to use a large container, the user may also adjust the length of the compartment to the length of that container. If not to be operated by the user, the length of the container may have a length that is suitable to fit into a predetermined length of the compartment, as for example dictated by the limits of a space or by other personal.

### Configuration of the Body-Worn/Carried Pump Station

The body-worn/carried pump station may, in a preferred embodiment, be provided with at least one door protecting the inner parts of the body-worn/carried pump. In particularly, the body-worn/carried pump is provided with a door for each compartment, so that the container may be replaced without exposing the battery and motor area.

### Container

In one embodiment of the present invention, the container is a collapsible container. The advantage of this is that as the material is dispensed, the container gets smaller and smaller such that the container can easily be carried and binned so as to occupy a minimal volume in for example a waste bin. Similar to being collapsible, the container may also be expandable from its collapsed configuration. In this way, the container can be filled with a material and fill up its expanded volume.

In order to bin the container and/or to insert a new container, the container may be both attachable and detachable from the compartment.

### Carrying Means

By body-worn device is meant a device that is made specifically for carrying on the body. It may be light-weight and comfortable. Furthermore, it may be easy to handle.

For carrying the body-worn/carried pump station, the housing may be provided with means for carrying the pump station by hand.

In a preferred embodiment, the housing is provided with means for carrying the pump station on the back of a person. In an alternative embodiment, the housing is provided with means for carrying the pump station over a shoulder or on the front of the person. This is easier than carrying the pump by hand, and allows the user to have both hands in operation so as to dispense and control the body-worn/carried pump station while carrying it.

In an alternative embodiment, the housing is provided with wheels such that it can be pulled rather than carried. This may ease the transport of the body-worn/carried pump station.

In one embodiment of the present disclosure, the pump and the container is arranged along an axis through the housing. The advantage of this is configuration is that it allows for a compact configuration which may be ideal for a body-worn device. In this configuration, the performance of the pump may be optimized for providing the optimal pressure to the container, as well as the configuration allows for a reduced electrical wiring.

### The Pump

In one embodiment of the present disclosure, the pump is a high-pressure pump. This means that the pump may provide a pressure of more than 10 bars and up to several hundreds of bars, such as more than 50 bars, such as more than 100 bars, such as more than 150 bars, such as more than 200 bars. One advantage of the present disclosure, wherein the pump is a high-pressure pump, is that this allows for high pressure supplying of the material to be pumped.

### The Flow Meter

In one embodiment of the present disclosure, the pump has an integrated flow meter. This may allow for reduced weight and reduced cost, and facilitates measuring the amounts delivered by the pump.

In another embodiment of the present disclosure, the flow meter is on the hose, the control means, the dispensing means or the display. Accordingly, the flow meter may be a physical unit attached to the hose, the control means or the dispensing means and communicating with the display in order to provide a visual indication of the flow.

The flow meter may be used to check that the preferred flow rate is achieved. For example, the preferred flow rate may be such that it allows the pumpable material to be dispensed into relevant machine parts, i.e. the flow rate must be such that there is sufficient time for the pumpable material to flow into machine parts, in particular small machine parts. In other words, the flow rate may not be too high, as this may prevent the pumpable material to flow into machine parts, in particular small machine parts. The preferred flow rate may be determined from the flow meter, in particular from the flowmeter itself or from communicating with the display. Alternatively, the flow rate may be determined from the motor, in particular from the speed of the motor and how the speed of the motor is regulated. Accordingly, the flow meter may be used to check leaks or other defects in the pump station, for example by comparing two determined flow rates with each other.

Furthermore, the flow meter may be used to determine the dispensed volume or rather the remaining volume of the pumpable material. In this way, it may be possible to look at the flow meter or any display of the flow instead of checking the remaining volume of the pumpable material in the container. The flow meter itself may be indicating the dispensed or the volume of the remaining pumpable material, so that it can be checked. Alternatively, since the flow rate is related to the dispensed pumpable material, there may be means for calculating the volume of the remaining pumpable material, such that the volume of the remaining pumpable material may be displayed elsewhere, in particular on the display.

### The Internal Power Supply and Motor

The motor is powered by an internal power supply such as a battery, preferably a rechargeable battery, and may in some embodiments in addition to the internal power supply also be powered by external power supply such as electricity. In order to use external power supply, an external power supply plugin may be implemented in the body-worn/carried pump station.

The motor may be any suitable motor. In one embodiment the motor is a permanent magnet motor due to the lesser power demand as compared a separately excited motor.

Preferably, the battery is to be charged inside the housing by connecting power to the plugin for charging. However, in some embodiments of the present disclosure, the battery is attachable and detachable from the compartment. This is an advantage, if the battery is to be replaced during use, for example if the job to be performed with the pump system requires more energy than what is available in one battery, then it is possible to insert a new battery or another recharged battery.

If for example, no batteries are available, or if the pump station is to be used for a long time at a specific location, the pump station may be configured to be powered by external power supply such as electricity.

### The Hose

In one embodiment of the present disclosure, the hose is replaceable with another hose. This may be the case, where for example, the hose is configured to the material type. Different materials are for example to be used with the body-worn/carried pump station. The hose may preferably be less than 15 meter long, in particular less than 1 meter, 2 meter or 3 meter, 4 meter, 5 meter, 6 meter, 7 meter, 8 meter, 9 meter, 10 meter, 11 meter, 12 meter, 13 meter, or less than 14 meter. In a preferred embodiment of the present disclosure, the length of the hose may be configured such that it is able to reach from the housing of the pump station, for example when it is carried on the back of a person, to one of the hands of the person, for example when the person stretches his arm. In another preferred embodiment of the present disclosure, the length of the hose depends on the differential pressure over the hose(s) and whatever units that may be coupled to the hose(s).

Materials to be Used with the Body-Worn/Carried Pump Station

The material to be pumped by the present body-worn/carried pump is in principle any pumpable material. In particular the material is a liquid, such as a grease, oil, grout, sealant, paint, herbicides, or insecticides. Grease may be used for lubricating parts of an engine. Liquids, such as oils, may however also be used for lubricating parts of an engine. Liquids, such as grout, may be used for repairing an engine or construction. Herbicides and insecticides may be dispensed to plants in for example a large field.

### Control of the Body-Worn/Carried Pump Station

The body-worn/carried pump according to the present invention comprises a control means for controlling the pump as well as a display. Either the control means or the display or both is/are located remotely from the housing. When both are located remotely from the housing the control means and the display may be integrated.

Accordingly, the control means may be positioned on the housing of the body-worn/carried pump station, or remotely therefrom.

When the control means is positioned on the housing it is preferred that it is operable for example through stepwise control so that the user may operate the pump even when the pump is positioned on the back of the user. The control means may also be several buttons or switches. Thereby, the user may adjust for example the volume to be pumped through one button even though the user cannot see the button/switches. Alternatively, the control means may be voice control. Thereby, the user may for example adjust the volume to be pumped, or for example engage the on/off button/switch, if both hands are in use or the user cannot see the button or switches. Alternatively, a second user may set the control means before the body-worn/carried pump is to be used.

In most embodiments, the control means is positioned remotely from the housing, and connected to the housing and parts therein either in a wired manner or wireless. If wired, there may be an adaptor for wired communication implemented in the body-worn/carried pump station. The control means may thus be positioned at the hose or the pump, or the control means may be implemented in a computer or handheld device, such as a smartphone or tablet.

It is preferred that the control means may be activated by the carrier of the pump, however as discussed above a second operator may be necessary or desired in some embodiments. Even when the pump is controlled through a control means implemented in a computer or the like, a second operator may take part in the controlling of the pump, optionally on instructions from the carrier.

In one embodiment of the present disclosure, the control means may be set to deliver a predetermined volume of material. In many applications it is desired that an exact volume is delivered so that the machine part receives an optimal dose and spillage is avoided. Accordingly, it is often an advantage in that the user may be restricted to only use a predetermined volume for example per part. The predetermined volume may be the optimal volume to dispense to a given part at a preferred flow rate as described in relation to the flow meter.

The volume may be controlled for example if the control means includes a control of the pump, such as a control of open/close, a control of flow, and/or a control of pressure. The control means may be navigation in an interface, such as navigation in menus, in order to control the pump station. Further, the body-worn/carried pump station may comprise an on/off button or switch.

In one embodiment the control means is integrated with the dispensing means and provided in the form of a gun, whereby the control means is a trigger. This provides the most direct control of the dispenser.

In another embodiment of the present disclosure, the control means is located on said hose or detached from the pump as a handheld device. All these positions allows for the carrier to control the pump directly.

### Dispensing Means

As described, the dispensing means may be provided in the form of a gun. The dispensing means may also be a hose, for example extending from a gun or the like, or from the control means. If however, the control means are located remote from the housing, the dispensing means may be the hose itself as connected to the housing.

The dispensing means may be provided with application tools such as a nozzle, in particular a spray nozzle or a brush nozzle. Furthermore, the dispensing means may be provided with couplings or fittings.

### Display of the Body-Worn/Carried Pump Station

As discussed above the display may be positioned on the housing or remote therefrom, wherein the latter is preferred to facilitate the control of the body-worn/carried pump when in use carried by the user. The display may be a wired device or a wireless device.

In one embodiment of the present disclosure, the display is located on said dispensing means or hose, preferably integrated with the control means, whereby the user during pumping may monitor and/or control the function of the pump.

In another embodiment the display is located separate from the housing, hose or dispensing means, such as in a computer, such as a handheld computer, or a smartphone or tablet. When the display is located separate from the housing, hose or dispensing means, it may be integrated with a remote control means.

Regardless of the location and type of the display, the display may be configured for controlling said control means. In particular, if the display is a touch screen, the buttons for controlling the control means are on the display. The buttons may be localized in menus.

In one embodiment of the present disclosure, the display is configured for observing said control means. This may allow the operator to follow the dispensed material in a quantitative way, while not necessarily operating the control means. The operator may of course also be allowed to operate the control means.

The display may be anything from a high resolution display, such as a smart phone like display or a computer screen or a tablet screen, to a simple LED display, depending on the type of information desired. Accordingly, an LED display may provide the sufficient level of information for many purposes.

### Preparation of the Body-Worn/Carried Pump

In the operation of the body-worn/carried pump station, preparing said body-worn/carried pump station may be required.

In one embodiment of the present disclosure, attaching a container into the compartment may be required, for example if the compartment is empty, optionally proceeded with a step for filling the container with material to be used.

Before use a hose should also be attached to the housing and dispensing means. In particularly, if different types of material are to be pumped using the same pumping station it is desired to have specific hoses for each type of material. Also different lengths of the hose may be used depending on the location of the parts to be provided with the material.

Also, before using the body-worn/carried pump station, the battery is recharged or a charged battery must be inserted into the compartment and connected.

In another embodiment of the present disclosure, supplying the body-worn/carried pump station with external electricity may be required, for example if no batteries are available.

### Carrying or Wearing the Body-Worn/Carried Pump

To allow the user to use both hands during the pumping it is an advantage that the pump station is to be worn on the body, in particularly worn as a back-pack on the back of the user, over the shoulder, or on the front of the user, during use.

However, when providing the pump station to the location to be used it may be carried by hand or rolled on wheels attached to the housing.

### Dispensing Material Using the Body-Worn/Carried Pump

The present invention allows the user to dispense pumpable material at any location needed, and furthermore, allows the user to control the pump and monitor the pump.

The dispensing means is preferably adapted to the parts to receive the material, whereby dispensing of the material may be conducted by pointing the hose or gun towards the parts to properly dispense the material.

In one embodiment of the present disclosure, the dispensing step is observing the flow meter in order to validate that the flow is correctly set.

In another embodiment of the present disclosure, setting the control means to deliver a predetermined volume of material may be required.

### Use of Body-Worn/Carried Pump

The use of the body-worn/carried pump may for example be desirable in work related to dispensing a given amount of pumpable material to a subject and then move onto a next subject in order to continue dispensing.

In one embodiment of the present disclosure, the use of the body-worn/carried pump station is for dispensing pumpable material to subjects such as plant parts or machine parts scattered on a large area, for example a solar cell plant, a car park, or a field of plants.

In another embodiment of the present disclosure, the use of body-worn/carried pump station is for dispensing pumpable material to subjects such as machine parts or construction parts within a confined space, for example inside a windmill.

### Locking Means and Projection Means

In a preferred embodiment of the present disclosure, the locking means are configured for locking said connector to said device or said container. In this way, the container remains in position during use. In a preferred embodiment, as previously described, one advantage of the locking means is that the locking means may lock the container to the device after the container is connected to the device. Furthermore, another advantage of the locking means is that in some embodiments, the locking means may open the valve. Accordingly, the valve may open after the container is connected to the device only, preventing dripping or flow of pumpable material from the container.

The locking means comprises, in a preferred embodiment, projection means configured for engaging said device or container. The projection means are preferably arranged to provide for applying a great torque with a small amount of force such that the locking operation is done easily. The projection means may be configured for engaging in a slot or hole in the device or the container.

In a preferred embodiment, in order for the locking means to engage the device or the container, the device or the container may comprise a part having an inner surface and an outer surface, and the engagement is preferably performed on the outer surface. In a preferred embodiment of the present disclosure, the engagement is performed in groove, and accordingly, the outer surface may comprise a groove for engaging the locking means. Preferably, the part having an outer surface is essentially cylindrical.

In one embodiment of the present disclosure, the groove is configured as a helix or as part of a helix. As previously described the groove may be on the device or the container. However, in some embodiments, the groove may be on the connector. The projection means may be engaging to the groove, such that the first or second connector may follow the track of the helix, meaning that the first or second connector may simultaneously rotate and slide on the outer surface of the device or container on which the connector thereby is engaged to and thereby locked to.

The groove may comprise a first stopping means for the projection means in the beginning of said groove and a second stopping means for said projection means at the end of said groove. Hence, the stopping means may be configured for holding said projection means in position and thereby holding said valve open or closed. In this way, the valve may in particular be closed and kept closed when the projection means may be in the beginning of the groove whereas the valve in particular may be open and kept open when the projection means may be at the end of the groove. The beginning of the groove may be a position closer to the opening of the device or the container than the end of the groove.

In one embodiment of the present disclosure, the stopping means is a pin connected to the inside of said groove. In particular the pin may be connected to the inside of the groove through a hole on a surface between the inner surface and the outer surface of the device or the container.

In a preferred embodiment of the present disclosure, the projection means is a rod extending from the outside of the connector and allowing the connector to rotate at least partly in relation to the container or the device. An advantage of having a rod is that it may be easy to move, thereby rotating either the first or the second connector such that it may slide on the outer surface of the device or the container, thereby pulling the second or first connector and consequently applying a pressure on the valve, such that the valve opens.

The projection means may be engaging the groove. In one embodiment the rod is screwed into the connector through a threaded hole to the inside of the connector and into the groove. Accordingly, the projection means may be a threaded rod or a partly threaded rod.

### Aperture Surface

In a preferred embodiment, the device or container comprises an aperture surface. The aperture surface may in particular be connected to the inner surface of the device or the container, for example by a screwing it into a threading in the inner surface. However, it may also be an integrated part of the device. Preferably, the device or container comprises an aperture surface which may be partly covering the opening. The aperture surface preferably comprises a plurality of apertures in order for allowing pumpable material to enter the device from the container. The apertures are preferably positioned off-centre, thereby leaving the centre solid. Accordingly, the aperture surface is preferably in the centre of the opening. In this way, the aperture surface may be configured for applying pressure to said valve.

### Valve

The valve is any suitable valve, and is preferably a cone-valve.

It is preferred that the valve is biased by a spring, such as a spring comprising a maximal force less than 100N, such as less than 90N, such as less than 80N, such as less than 70N, such as less than 60N, such as less than 50N, such as less than 40N, such as less than 30N, such as less than 20N, or such as less than 10N. The spring may be a part of the valve, meaning that it may be connected to the valve such that in order to open the valve, the spring has to be compressed according to the max force that the spring may comprise.

Accordingly, a valve surface may be configured for being pressed in order to open said valve. Also, the force may be applied on said valve-surface.

The spring may be compressed by moving the projection means along the groove, thereby opening the valve.

### Connector

In one embodiment of the present disclosure, the connector is configured for sliding on or along said outer surface. Accordingly, the mounting means may comprise an inner mounting surface and an outer mounting surface which are greater than the outer surface of the device or the container. Furthermore, the roughness of the inner mounting surface may be such that there is low friction between the connecting surfaces. Likewise, the roughness of the outer surface of the device or the container may be such that there is low friction between the connecting surfaces.

The connector may comprise locking means, wherein the locking means may be the projection means, such that the connector may be configured for being rotated by moving said projection means.

The two connectors may be connected, such that the first connector and/or said second connector may be configured for sliding on or along said outer surface, when said second connector or first connector is rotated. This means that the second or third connection means may be configured for connecting to each other in particular such that rotation of one connector relative to the other connector is possible while connected.

In one embodiment of the present disclosure, the connector is configured for sliding on said outer surface such that said aperture surface applies a positive or negative force on said valve such that said valve opens or closes. Accordingly, the aperture surface may be solid at the point of contact with the valve. Preferably, the aperture surface may be solid in the centre of the surface.

In some embodiments of the present disclosure, the connector is comprised of a plurality of connectors, each comprising an inlet and an outlet. In this way, the valve may for example be inserted in between two connectors, for example for allowing an easy assembly of a connector. Furthermore, there may be configurations, where a connector may be comprised of a plurality of connectors is an advantage, for example, if a space between a container and a device needs to be at a certain distance, or if for example the projection means needs to be at a specific distance from the device or the container. For the latter example, it may be if the projection means needs to be at a position where access is permitted.

In a preferred embodiment the connector is a cylindrical. Accordingly, all the connectors may be cylindrical.

In one embodiment of the present disclosure, the first connector is configured for rotating on said outer surface without rotating said second connector, in particular by having the second mounting means or the third mounting means as an annular groove to which the third or second mounting means connects with two parallel surfaces. In this way, the device or the container may not rotate when the first connector is rotating on the outer surface.

In another embodiment of the present disclosure, the second connector is configured for rotating on said outer surface without rotating said first connector, in particular by having the second mounting means or the third mounting means as an annular groove to which the third or second mounting means connects with two parallel surfaces. In this way, the device or the container may not rotate when the first connector is rotating on the outer surface.

### O-Rings

According to an embodiment of the present disclosure, the device or container may comprise an O-ring to seal the device.

In another embodiment of the present disclosure, the connector may comprise an O-ring to seal the valve and the container. In a preferred embodiment of the present disclosure, the connector may comprise two O-rings.

### Mounting Means

In a preferred embodiment of the present disclosure, the mounting means comprises an inner mounting surface and an outer mounting surface.

In one embodiment of the present disclosure, the first mounting means is a threaded mount, preferably on the inner mounting surface. The first mounting means may be pre-connected to the container. The first mounting means may comprise a valve, such that the valve may prevent the pumpable material to exit from the container. By having pre-connected the first mounting means on the container, there may be only two connections left for connecting a container to a device.

In another embodiment of the present disclosure, the mounting means is an un-threaded mount.

In another preferred embodiment of the present disclosure, the second mounting means or said third mounting means may comprise an annular groove. As previously described, it is desirable to have a connection to the second or third mounting means, such that only one of the connectors may be free to rotate. Accordingly, the second mounting means or said third mounting means may comprise two parallel surfaces to slide onto said annular groove.

In one embodiment of the present disclosure, the fourth mounting means is a threaded mount. However, in a preferred embodiment, where a user-friendly connector is desired, in particular a fast connection, the fourth mounting means is an un-threaded mount. The fourth mounting means may in a preferred embodiment be pre-connected to the device. By having pre-connected the first mounting means on the container, and having pre-connected the fourth mounting means on the device, there may be only one connection left for connecting a container to a device. According to the previously described embodiments, the connection to be made may be a sliding of a container with a pre-connected first connector, into a device or into a housing comprising a device with a pre-connected second connector. According to the present disclosure, the sliding may be a translational movement of the connector, and the translational movement may be substantially perpendicular to an axis formed along said first outlet and second inlet when the connectors are connected, such that the connection may be user-friendly in terms of handling, the connection may in particular be fast and easy. After connecting the container to the device as described, there may be a locking of the container to the device. As previously described, this may be achieved by moving a rod, again making the connection and locking easy and fast, and particular in a way that may require no rotation of the container. Furthermore, the sliding may according to the present disclosure be a translational movement of the connector, and the translational movement may be substantially perpendicular to an axis formed along said first outlet and second inlet when the connectors are connected, such that the connection of a container to a device, makes the disclosed container connector assembly suitable for connecting a container to a device inside a compact housing, in particular suitable for connecting a container to a pump inside a compact housing.

### Pump System

As previously described, the device to which the container connector assembly may be connected to, may be a pump, for example a pump in the pump station as above described. Accordingly, the container may be a container in the pump station. Accordingly, the device opening may be an inlet for a pump. Furthermore, the container may be a compressible container used for a pump. The container may accordingly comprise pumpable material.

1-106. (canceled)

107. A body-worn/carried pump station comprising:
a housing having at least one compartment;
at least a pump, a motor and an internal power supply disposed in the housing, said motor being powered by said internal power supply;
a container adapted to contain material to be pumped, wherein said pump has a connector for connecting said container;
at least one hose having one end connected to said pump and an other end connected to a dispenser for dispensing material pumped from the container;
a control for start/stop and/or for controlling and/or setting up said pump station, wherein said control is located remotely from said pump station; and
a display.

108. The body-worn/carried pump station according to claim 107, wherein said container is a collapsible container.

109. The body-worn/carried pump station according to claim 107, wherein the container is adapted to contain at least 1 liter of material.

110. The body-worn/carried pump station according to claim 107, wherein the total length of the pump station housing is less than 100 cm.

111. The body-worn/carried pump station according to claim 107, wherein the pump is a high-pressure pump, wherein the pump provides a pressure of more than 10 bars.

112. The body-worn/carried pump station according to claim 107, wherein the control is set to deliver a predetermined volume of material.

113. The body-worn/carried pump station according to claim 107, wherein the control is set to deliver a predetermined volume of material at a preferred flow rate.

114. The body-worn/carried pump station according to claim 107, wherein the display is a wireless device.

115. The body-worn/carried pump station according to claim 107, wherein the display is a smart phone display.

116. The body-worn/carried pump station according to claim 107, wherein the display is a screen.

117. The body-worn/carried pump station according to claim 107, wherein the pump and the container are arranged along an axis through the housing.

118. The body-worn/carried pump station according to claim 107, wherein the housing is provided with means for carrying the pump station on the back of a person.

119. The body-worn/carried pump station according to claim 107, wherein the material is grease.

120. The body-worn/carried pump station according to claim 107, wherein the material is liquid.

121. The body-worn/carried pump station according to claim 107, wherein the material is grout.

122. The body-worn/carried pump station according to claim 107, wherein the pump has an integrated flow meter configured to calculate the volume of the remaining pumpable material, such that the volume of the remaining pumpable is displayed on the display.

123. The body-worn/carried pump station according to claim 107, wherein the pump system comprises a flow meter configured to check that a preferred flow rate of the pumpable material being dispensed is achieved.

124. The body-worn/carried pump station according to claim 107, wherein the pump station further comprises:
a container connector assembly, comprising:
a first connector comprising a first inlet and first outlet,
a second connector comprising a second inlet a second outlet,
a first mount on said first connector for connecting said first connector to a container comprising a container opening,
a second mount on said first connector for connecting said first connector to said second connector,
a third mount on said second connector for receiving said first connector,
a fourth mount on said second connector for connecting said second connector to a device comprising a device opening,
a valve inside said first connector and/or inside said second connector to be opened and closed,
wherein said second and/or third mount is configured for connecting said first connector to said second connector by a translational movement of said connector(s), and wherein said translational movement is substantially perpendicular to an axis formed along said first outlet and second inlet when the connectors are connected.

125. Use of the body-worn/carried pump station according to claim 107 for dispensing pumpable material to subjects such as plant parts or machine parts scattered on a large area, for example a solar cell plant, a car park, or a field of plants.

126. Use of the body-worn/carried pump station according to claim 107 for dispensing pumpable material to subjects such as machine parts or construction parts within a confined space, for example inside a windmill.
